(19) United States
(12) Patent Application Publication
(10) Pub. No.: US 2004/0088873 A1
(43) Pub. Date: May 13, 2004

(54) High contrast spirit-level vial

(76) Inventors: Joel Lang, Givataim (IL); Assif Stoffman, Kfar-Yona (IL)

Correspondence Address: NIXON & VANDERHYE, PC, 1100 N GLEBE ROAD, 8TH FLOOR, ARLINGTON, VA, 22201-4714, US

(21) Appl. No.: 10/354,167

(22) Filed: Jan. 30, 2003

Related U.S. Application Data
(60) Provisional application No. 60/425,297, filed on Nov. 12, 2002.

(51) Int. Cl. G01C 9/24

(52) U.S. Cl. 33/379

(57) ABSTRACT

A spirit-level vial comprising a transparent vessel containing a globule of a first liquid suspended in a medium comprising a second liquid, wherein said transparent vessel is essentially completely filled by said medium, and wherein said globule is capable of moving freely through said medium in response to changes in the spatial orientation of said transparent vessel.

### FIELD OF THE INVENTION

The present invention relates to a device for use in determining whether surfaces are level. More specifically, the present invention relates to a spirit-level vial containing a liquid drop or globule suspended within a second liquid medium.

### BACKGROUND OF THE INVENTION

The use of spirit-levels (also sometimes known as bubble levels) and other related leveling devices (such as clinometers) in a variety of engineering and domestic settings is well known in the art. In its most usual form, the spirit-level consists of a rigid-walled, transparent vial or capsule partially filled with a liquid, into which is entrapped a bubble. By means of suitable markings placed either on the capsule itself or on a base member supporting said capsule, the user is able to determine when the device is placed in a level orientation in relation to a desired plane. This simple spirit-level design has changed little over the years and is generally recognized as having the advantages of simplicity of construction and reasonable accuracy.

One significant drawback of the basic spirit-level design, however, is the difficulty commonly encountered in reading the device. This difficulty is essentially one of insufficient contrast or visual differentiation between the liquid contained in the vial and the bubble entrapped therein. This problem is further exacerbated by the poor lighting conditions that prevail in many of the working environments in which spirit-levels are used.

Many attempts have been made over the years to overcome the problem of poor visibility or readability of spirit-levels. The attempted improvements made to the basis design include the addition of one or more of the following structural features: a reflective surface beneath the fluid-containing vial, a color-contrasting background, fluorescent liquids within the vial, externally placed viewing prisms (in order to accentuate the differences in refractive index of the liquid and the bubble) and illumination of the vial. These various prior art attempts are reviewed in U.S. Pat. Nos. 4,164,077 and 4,407,075.

It may be readily be appreciated from the foregoing partial list of prior art approaches that all of the previous attempts to increase the contrast between the liquid within the vial and the bubble suspended therein have focused either on changing the visual properties of the liquid (either directly, or by the use of contrasting backgrounds) or on increasing the overall illumination levels. While some of the abovementioned prior art approaches have led to partial improvements in readability, a need still exists for a spirit-level vial having substantially increased contrast between the liquid and the suspended bubble.

The aim of the present invention, which will shortly be disclosed and described hereinbelow, is to provide a spirit-level vial having significantly improved readability.

A further aim of the present invention is to provide an improved spirit-level vial in which the increased visual contrast between the vial liquid and the bubble suspended therein is obtained by altering the structure and properties of said bubble.

It is a still further purpose of the invention to provide a spirit-level vial that overcomes the disadvantages of prior art vials.

Further objects and advantages of the present invention will become apparent as the description proceeds.

### SUMMARY OF THE INVENTION

It has now been unexpectedly found that it is possible to manufacture a spirit-level vial having significantly improved readability in which the air bubble of the conventional type of spirit-level is replaced by a drop or globule of a first liquid that is suspended within a second liquid medium that fills said vial. By careful selection of the type and color of the liquid used to form the drop or globule and of the liquid medium, it is possible to obtain very high visual contrast between these two components.

The present invention is primarily directed to a spirit-level vial comprising a transparent vessel containing a globule of a first liquid suspended in a medium comprising a second liquid, wherein said transparent vessel is essentially completely filled by said medium, and wherein said globule is capable of moving freely through said medium in response to changes in the spatial orientation of said transparent vessel.

Although the term “globule” is conventionally understood to refer to a small spherical figure such as a small ball, orb or globe, for the purposes of the present invention, the globule that is suspended within the second liquid medium may also be present in other, related, geometrical forms that are not perfectly spherical, such as an oblate sphere, an elongated sphere or a tear-drop shape. The term is also used in its present context to indicate that the volume of said “globule” is very small in relation to the volume of the second liquid medium, in which said globule is suspended.

The phrase “a globule of a first liquid suspended in a medium comprising a second liquid” is to be understood in the sense that the mutual immiscibility of the two liquids is such that the globule constitutes a distinct phase within the second liquid, there being no substantial change in the volume, mass or shape of said globule over a time frame corresponding to the usual (or desired) working lifespan of the spirit-level vial disclosed herein.

According to a particularly preferred embodiment of the present invention, the first solvent constituting the glouble and the second solvent constituting the medium have distinctly different densities, which densities are designated ρ₁ and ρ₂, respectively, such that either ρ₁ is greater than ρ₂, or ρ₂ is greater than ρ₁. Preferably, |ρ₁−ρ₂|≧0.1 g/cc, and more preferably, |ρ₁−ρ₂|≧0.3 g/cc.

The transparent vessel of the present invention may be constructed of any suitable material of sufficient transparency or translucency that is compatible with the first and second liquids that are to be contained therewithin, as will be discussed at greater length hereinbelow. It is to be noted that the term “transparent” in this context is to be understood as including within its scope both fully transparent vessels, as well as translucent vessels, whose degree of transparency is sufficient to permit convenient use of the spirit-level vial of the invention. Said transparent vessel may also be formed into any convenient shape that is compatible with the intended function of the spirit-level vial, including tube-like, hemispherical, capsular, and the like. Most preferably, the transparent material is selected such that the first liquid constituing the globule, when brought into contact with said transparent material, is repelled therefrom, that is, said first liquid is not attracted by said transparent material, thus allowing the preservation of said first liquid in its globular form. Particularly preferred materials having this property are polypropylene or its derivative, polymethylpentene.

The first and second liquids used to manufacture the spirit-level of the present invention may be any suitable liquids or mixtures of liquids that possess the physical properties described hereinabove.

As used hereinafter, the term “aqueous liquid” refers to a liquid which is either water alone or water to which has been added one or more water-miscible liquids and/or into which has been dissolved one or more water-soluble solutes.

As used hereinafter, the term “organic liquid” refers to any carbon-containing substance which is in the liquid state in the relevant temperature range, that is, in the range of temperatures in which the vessel according to the invention is intended for use, or to mixtures of such substances.

As used hereinafter, the term “inorganic liquid” refers to silicon oils or silicon fluids or ionic liquids.

According to one preferred embodiment of the invention, there is provided a spirit-level vial comprising a transparent vessel containing a globule of a first liquid suspended in a medium comprising a second liquid, wherein the first liquid is an aqueous liquid and the second liquid is either an organic liquid or inorganic liquid, and wherein ρ₂ is greater than ρ₁. Preferably, ρ₂ is greater than 1.0 g/cc, and more preferably, ρ₂ is greater than 1.1 g/cc.

Preferably, the aqueous liquid comprises a mixture of water and water-miscible lower alcohol, which is preferably methanol or ethanol. More preferably, the aqueous liquid is mixture comprising (by weight) 90% water and 10% methanol.

It has been found that in the case wherein the first liquid constituing the globule is an aqueous liquid, then the second liquid, having a value of ρ₂ that is greater than 1.0 g/cc, and more preferably, greater than 1.1 g/cc, is preferably a halogenated aliphatic compound, and is more preferably, selected from the group consisting of halogenated C₁-C₁₀ straight or branched alkanes, halogenated C₃-C₁₀ cycloalkanes, halogenated straight or branched C₂-C₁₀ alkenes, halogenated C₃-C₁₀ cycloalkenes, halogenated C₂-C₁₀ straight or branched alkynes. Halogenated aromatic hydrocarbons may also be used according to the this embodiment of the invention.

The term “halogenated” is used herein to refer to substances in which one or more halogen atoms are bonded to carbon atoms, wherein said halogen atoms are either fluorine, chlorine, bromine or iodine, or combinations thereof. It should be understood, however, that any organic liquid having density greater than 1.0 g/cc may be used as the medium liquid according to this embodiment.

According to another preferred embodiment of the invention, the first liquid is either an organic liquid or inorganic liquid and the second liquid is an aqueous liquid, wherein ρ₁ is less than 1.0 g/cc, and more preferably, ρ₁ is less than 0.9 g/cc.

It has been found that in the case wherein the first liquid constituing the globule is an organic liquid and the second liquid is an aqueous liquid, then the first liquid, wherein ρ₁ is less than 1.0 g/cc, and more preferably, ρ₁ is less than 0.9 g/cc, is preferably selected from the group of consisting of C₅-C₁₀ straight or branched alkanes, C₅-C₁₀ cycloalkanes, straight or branched C₅-C₁₀ alkenes, C₅-C₁₀ cycloalkenes and C₅-C₁₀ straight or branched alkynes.

Aromatic hydrocarbons may also be used according to the this embodiment of the invention.

According to yet another preferred embodiment, both the first and second liquids are mutually immiscible organic liquids, wherein either ρ₁ is less than ρ₂, or vice versa.

Either one or both of the abovementioned first and second liquids may be strongly colored. In the event that only one of said liquids is strongly colored, the other may be essentially colorless. In the event that both of said liquids are strongly colored, each of said liquids is of a different, mutually-contrasting color. In one preferred embodiment of the invention, the first liquid is colored and the second liquid essentially colorless.

In a particularly preferred embodiment of the spirit-level vial of the invention, the first liquid is a colored aqueous liquid and the second liquid is an essentially colorless organic liquid, wherein said organic liquid has a higher density than said aqueous liquid.

The present invention is also directed to a spirit-level vial as defined hereinabove that further comprises visible calibrated markings on one or more surfaces of the transparent vessel.

The term “calibrated markings” is used herein to indicate that the positions of said markings on the transparent vessel have been either calculated or experimentally determined to be the positions corresponding to the rest positions occupied by the imaginary center point of the liquid globule when one of the axes of said vessel is tilted at certain, defined angular orientations of said vessel in relation to the horizontal plane.

In one preferred embodiment, the spirit-level vial comprises only one calibrated marking, wherein said marking corresponds to the rest position of the imaginary center point of the liquid globule when one of the axes of the vessel is orientated in the horizontal plane.

In another preferred embodiment of the invention, the spirit-level vial comprises a plurality of calibrated markings, each of which corresponds to a pre-determined angular orientation of one of the axes of the transparent vessel in relation to the horizontal plane.

In another aspect, the present invention also provides a spirit-level comprising:

a) one or more spirit-level vials as defined hereinabove and described in more detail hereinbelow;

b) a base element upon which said one or more spirit-level vials are mounted; and

c) one or more calibrated markings, wherein said calibrated markings are present on the surface of the transparent vessel of each of said one or more spirit-level vials and/or the surface of said base element adjacent to said transparent vessel.

The base element used to construct the abovementioned spirit-level may be constructed of any suitable material including wood, synthetic polymers, aluminum and other metals and alloys. The spirit-level vials may be attached to said base element by any convenient method known to the skilled artisan, including gluing, heat welding and affixing with straps or bands that are screwed, welded or riveted to said base element.

It is to be noted that the term “spirit-level” as used throughout this document is used in its conventional meaning to refer to a suitable device for determining whether a surface upon which said device rests is level. Likewise, the term “spirit-level vial” is used to refer to the liquid-containing vial or capsule that forms part of said “spirit-level”. Despite the fact that the “spirit-levels” and “spirit-level vials” of the present invention are not limited to devices containing “spirit”, (for example, alcohols or alcohol mixtures such as used in most earlier devices that are described by this term), these terms are retained for reasons of convention and convenience of description, and are to be understood as being interchangeable with the terms “level-determining device” and “level-determining device vials”.

All the above and other characteristics and advantages of the present invention will be further understood from the following illustrative and non-limitative examples of preferred embodiments thereof.

### DETAILED DESCRIPTION OF PREFERRED EMBODIMENTS

The conventional spirit-level vials of the prior art are constructed such that they contain an air bubble suspended in a liquid medium. Clearly, said bubble is less dense than said medium, and as a result has a tendency to move towards the upper end of the vial when it is tilted away from the horizontal plane. For the purposes of the present discussion, this may be considered to be the conventional mode of operation for spirit-level vials. By analogy with the traditional air-bubble spirit-levels, the vials of the present invention may also be arranged such that they operate in the conventional mode, by means of using a first liquid (i.e., the liquid globule) that is less dense than the second liquid medium in which it is suspended. Alternatively, the spirit-level vial of the present invention may be so arranged as to operate in reverse mode, such that the liquid globule has a tendency to move towards the lower end of the vial when said vial is tilted away from the horizontal plane. It is to be emphasized that the present invention encompasses spirit-level vials of both operating modes within its scope.

A key feature of the design of the present invention is that the first liquid and the second liquid (as defined hereinabove) be mutually immiscible, in order to retain the unique two-phase globule-medium liquid composition. As mentioned hereinabove, this may be achieved by using a combination of either two immiscible organic liquids, or a combination of an organic liquid and an aqueous liquid, or a combination of an inorganic liquid and an aqueous liquid. Taking into account these various two-phase liquid-liquid combinations, as well as the two basic operating modes mentioned hereinabove, the following seven different specific embodiments of the spirit-level vial of the present invention may be identified, as summarized in Tables Ia and Ib:

TABLE Ia
Conventional mode (second liquid denser than first liquid)

| | First Liquid | Second Liquid |
|---|---|---|
| Embodiment: | (globule) | (medium) |
| A | aqueous | organic |
| B | organic | aqueous |
| C | organic | organic |
| D | aqueous | inorganic |

Note:
the two organic liquids used in embodiment C are mutually immiscible.

TABLE Ib
Reverse mode (first liquid denser than second liquid)

| | First Liquid | Second Liquid |
|---|---|---|
| Embodiment: | (globule) | (medium) |
| E | aqueous | organic |
| F | organic | aqueous |
| G | organic | organic |

Note:
the two organic liquids used in embodiment F are mutually immiscible.

Tables IIa, IIb and IIc present non-limitative lists of organic, aqueous liquids and inorganic liquids that have been found to be suitable for working the present invention:

TABLE IIa
Examples of suitable organic liquids

1,6 dibromohexane
1,2,3 trichloropropane
1,5 dibromopentane
Carbon tetrachloride
Tetrahydrofuran
1,4 dichlorobutane
Trichloropropane
Petroleum ether
1,1,1 trichloroethane
Dichloromethane
trichloroethylene

TABLE IIb
Examples of suitable aqueous liquids

water
saline solution
ethanol
glycol solution

TABLE IIc
Examples of suitable inorganic liquids

polydimethylsiloxanes derivatives (Aldrich)

Many different dyes and other colored substances may be added to the aqueous liquids, the organic liquids, or both. Water-based food dyes have been found to be particularly suitable in this regard.

In order to reduce the freezing point of the above-listed aqueous liquids to below −20° C., methanol may also be added thereto in varying proportions. For example, it has been found that addition of methanol to water to a final concentration (by weight) of 5% leads to a reduction in the freezing point of the aqueous liquid by 3° C. Methanol concentrations of 20% (w/w) and 30% (w/w) were found to reduce the freezing point by 15° C. and 26° C., respectively. Thus different amounts of methanol may be added to the aqueous liquid in accordance with the desired working temperature range of the spirit-level vial.

A variety of other additives may also be added to one or both of the first and second liquids, in order to improve the efficiency, accuracy and reliability of the movement of the globule through the liquid medium, in response to changes in spatial orientation of the vial. In particular, these additives may be used to increase the speed of movement of the globule through the second fluid medium, on tilting of the vial. Such materials may be low viscosity organic materials such as petroleum ether or THF. These additives may also be lubricating materials, anti-foam additives and viscosity-reducing agents. In addition, appropriately-soluble salts may be added to the first liquid and/or the second liquid, in order to change the densities of one or both of said liquids, and to change the degree of immiscibility therebetween. It should be noted that according to the embodiment of the invention wherein the first liquid is an aqueous liquid and the second liquid is an organic liquid, wherein ρ₂ is greater than ρ₁, said organic liquid may be mixed with low viscosity organic liquids, such as, for example, heptane, hexane, n-octane, benzene and acetone, provided, of course, that the denisty of the resultant mixture is greater than ρ₁, in order to increase the velocity of the motion of the aqueous globule within the organic mixture.

Visibility-enhancing particles may be added to one or both of the first or second liquids in order to improve contrast between the globule and medium, and hence to facilitate reading of the spirit-level vial. Many different types of visibility-enhancing particles may be used in conjunction with the present invention, including: reflective hydrophobic polymer flakes or spheres, fluorescent particles (e.g., fluoroscein), and phosphorescent particles.

Several different materials have been tested for their suitability for use in the construction of the transparent vessels of the present invention, including Perspex, polyethylene, polypropylene, polyestertera-phthalate (non-blown) and polyesterteraphthalate (blown). While all of these substances have been shown to have varying degrees of suitability for use in working the present invention, polypropylene is a particularly preferred material. One example of a particularly preferred transparent polypropylene that may be used for constructing the transparent vessel of the present invention is QT-73, which is manufactured by Carmel Olifenes Ltd., Haifa, Israel. A further example is polymethylpentene (PMP), a modified polypropylene. According to another preferred embodiment of the invention, the transparent vessel is made of glass, wherein the internal walls of said vessel are appropriately coated, for example, with a thin semi-transparent layer of teflon.

The following example is provided for illustrative purposes and in order to more particularly explain and describe the present invention. The present invention, however, is not limited to the particular embodiment disclosed in this example.

### EXAMPLE

### Procedure for Preparing a Spirit-Level Vial Containing an Aqueous Globule Suspended in an Organic Medium

A 1 cc crimp cap type vial with a standard 11 mm fitting cap made of optically clear polymethylpentene (PMP X-22, manufactured by Mitsui Petrochemical Co., Tokyo, Japan) was used as the transparent vessel. The crimp cap was fitted with a teflon separator in order to provide complete compatibility with the organic solution. The vial was provided with an internal curvature radius of 10 inch radius. The vial was filled with 0.9 cc 1,2,3-trichloropropane (supplied by sigma). The vial was then immersed upright beneath a colored solution comprising 10% methanol, a few grains of a water-soluble food dye (supplied by Rudo, Israel) and 90% water. The water/methanol/dye solution filled the remaining 0.1 cc empty volume of the vial and while the vial was submerged beneath the said solution, it was crimped shut with a suitable crimper. This process ensures that no air may leak into the two liquid phases and that a known quantity of colored water/methanol solution is introduced into the vial. Suitable markings to state the level state of the water/methanol bubble were etched on the external surface of the vial.

While specific embodiments of the invention have been described for the purpose of illustration, it will be understood that the invention may be carried out in practice by skilled persons with many modifications, variations and adaptations, without departing from its spirit or exceeding the scope of the claims.

1. A spirit-level vial comprising a transparent vessel containing a globule of a first liquid suspended in a medium comprising a second liquid, wherein said transparent vessel is essentially completely filled by said medium, and wherein said globule is capable of moving freely through said medium in response to changes in the spatial orientation of said transparent vessel.

2. The spirit-level vial according to claim 1, wherein the first liquid has a higher density than the second liquid.

3. The spirit-level vial according to claim 1, wherein the second liquid has a higher density than the first liquid.

4. The spirit-level vial according to claim 1, wherein the first liquid is an organic liquid and the second liquid is an aqueous liquid.

5. The spirit-level vial according to claim 1, wherein the first liquid is an aqueous liquid and the second liquid is an organic liquid.

6. The spirit-level vial according to claim 1, wherein both the first and second liquids are organic liquids.

7. The spirit-level vial according to claim 3, wherein the first liquid is an aqueous liquid and the second liquid is an organic liquid.

8. The spirit-level vial according to claim 7, wherein the aqueous liquid comprises a mixture of methanol, water and a colored dye.

9. The spirit-level vial according to claim 7, wherein the organic liquid is a polyhalogenated aliphatic compound.

10. The spirit-level vial according to claim 9, wherein the polyhalogenated aliphatic compound is 1,6 dibromohexane.

11. The spirit-level vial according to claim 9, wherein the polyhalogenated aliphatic compound is 1,2,3 trichloro-propane.

12. The spirit-level vial according to any one of the preceding claims, wherein the first and/or second liquids further comprise visibility-enhancing particles.

13. The spirit-level vial according to claim 12, wherein the visibility-enhancing particles are fluorescent particles.

14. The spirit-level vial according to any one of claims 1 to 11, wherein both of the two liquids are strongly colored, and wherein two liquids are each colored with a mutually-contrasting color.

15. The spirit-level vial according to any one of claims 1 to 11, wherein one of the two liquids is strongly colored, the other liquid being essentially colorless.

16. The spirit-level vial according to any one of the preceding claims, wherein the transparent vessel is constructed of polypropylene.

17. The spirit-level vial according to any one of claims 1 to 15, wherein the transparent vessel is constructed of polymethylpentene.

18. A spirit-level comprising:
a) one or more spirit-level vials according to any one of the preceding claims;
b) a base element upon which said one or more spirit-level vials are mounted; and
c) one or more calibrated markings, wherein said calibrated markings are present on the surface of the transparent vessel of each of said one or more spirit-level vials and/or the surface of said base element adjacent to said transparent vessel.
